(19) United States
(12) Patent Application Publication
(10) Pub. No.: US 2013/0215929 A1
(43) Pub. Date: Aug. 22, 2013

(54) INDIRECT TEMPERATURE MEASUREMENTS OF DIRECT BANDGAP (MULTIJUNCTION) SOLAR CELLS USING WAVELENGTH SHIFTS OF SUB-JUNCTION LUMINESCENCE EMISSION PEAKS

(71) Applicant: Semprius, Inc., (US)

(72) Inventor: Etienne Menard, Limoges (FR)

(73) Assignee: Semprius, Inc., Durham, NC (US)

(21) Appl. No.: 13/766,497

(22) Filed: Feb. 13, 2013

Related U.S. Application Data
(60) Provisional application No. 61/599,737, filed on Feb. 16, 2012.
(60) Provisional application No. 61/704,162, filed on Sep. 21, 2012.
(60) Provisional application No. 61/704,889, filed on Sep. 24, 2012.

(51) Int. Cl. G01K 11/20

(52) U.S. Cl. CPC G01K 11/20
USPC 374/161

(57) ABSTRACT

Methods and structures may be used to measure operating temperatures of isolated cells and/or fully interconnected cells inside a Concentrator Photovoltaic (CPV) module. The method may use spectrometers to measure wavelength shifts of a sub-cell electro-luminescence and/or photo-luminescence emission spectrum. A sub-cells' intrinsic bandgap temperature-dependence relations may be used to indirectly compute the operating temperature of each subcell. A sub-cells' intrinsic bandgap temperature-dependence coefficients can be measured by performing quantum efficiency measurements and/or by recording the electro-luminescence and/or photo-luminescence emission profile of a solar cell at multiple temperatures.

### CLAIM OF PRIORITY

This application claims priority under 35 U.S.C. §119 to U.S. Provisional Patent Application No. 61/599,737, filed Feb. 16, 2012, U.S. Provisional Patent Application No. 61/704,162, filed Sep. 21, 2012, and U.S. Provisional Patent Application No. 61/704,889, filed Sep. 24, 2012, the disclosures of which are hereby incorporated by reference herein as if set forth in their entireties.

### FIELD

Embodiments of the present invention relate to the general field of photovoltaic solar cells and/or modules. More specifically, embodiments of the present invention relate to measurement of temperature of solar cells.

### BACKGROUND

Accurate measurements of the operating temperature of solar cells may be useful and/or necessary to improve and/or optimize thermal management solutions of photovoltaic modules, and/or to translate current-voltage (IV) curves of modules measured both indoors and on-sun to standard test conditions. However, performing accurate measurements of operating temperatures of concentrator solar cells may be technically challenging. For example, the use of thermocouples may be invasive and/or may damage surfaces of a solar cell, while infrared techniques may require the use of high sensitivity IR imagers to measure solar cells through encapsulant layers or optics.

The linear temperature-dependent variation of the voltage across semiconductor P/N junctions may be used to indirectly compute operating temperatures of a semiconductor. The open circuit voltage (Voc) of monolithically grown multi junction solar cells can be computed based on the sum of the subcells' Vocs when the subcell junctions are connected in series. The open circuit voltage temperature coefficient (∂V/∂T) can likewise be computed based on the sum of the temperature coefficients of each sub-cell. Unfortunately, this approach may have some drawbacks, for example, since: (i) the Vocs and temperature coefficients of each sub-cell are both functions of the incoming irradiance level, (ii) slight variations of epitaxial material quality from wafer-to-wafer or even across a single wafer can induce Voc changes from cell-to-cell, and (iii) leakage currents induced by non-radiative recombination losses may cause sub-junctions to have ideality factors higher than unity, introducing additional variations of each sub-cell's temperature dependence coefficients.

Despite the above, it may be possible to accurately measure the temperature coefficient of a solar cell forward biased using a fixed “sense” bias current. Once a reference Voc and temperature dependence coefficient are known for a given cell, transient temperature measurements can be performed using high “heat” current pulses and smaller “sense” bias current values as discussed, for example, by Jaus, J., et al., “Thermal management in a passively cooled concentrator photovoltaic module”, 23^{rd} EPVSEC, September (2008), the disclosure of which is hereby incorporated herein in its entirety by reference. Alternative methods involving the use of a mechanical shutter may be impractical at the module level and/or may typically be too slow to provide accurate measurements in the case of micro-solar cells, as discussed by Muller M., et al., “Determining outdoor CPV cell temperature,” 7th Int. Conf. on CPV Systems, April (2011), the disclosure of which is hereby incorporated herein in its entirety by reference.

### SUMMARY OF THE INVENTION

Methods and structures disclosed herein may provide accurate measurements of operating temperatures of isolated and/or fully interconnected cells inside a CPV module. Methods according to some embodiments of the present invention may use spectrometers to measure wavelength shifts of sub-cell electro-luminescence and/or photo-luminescence emission spectrum(s). The sub-cells' intrinsic bandgap temperature dependence relations may be used to indirectly compute each subcell operating temperature.

According to some embodiments of the present invention, in a method of determining a temperature and/or temperature changes of a solar cell in an array of solar cells emitting luminescent radiation, bandgap characteristic shifts corresponding to temperature shifts of the solar cells are established. A spectrometer input device is positioned to measure wavelength characteristic shifts of the luminescent radiation from the solar cells, and the wavelength characteristic shifts of the luminescent radiation from the solar cells are measured. The wavelength characteristic shifts of the luminescent radiation from the solar cells are correlated to the bandgap characteristic shifts corresponding to temperature shifts of the solar cells to determine the temperature and temperature changes of the solar cells.

In some embodiments, the luminescent radiation may be emitted responsive to incident solar radiation on said solar cells.

In some embodiments, the luminescent radiation may be emitted responsive to application of a forward electrical bias to said solar cells.

In some embodiments, the positioning of the spectrometer input device may be at an angle with respect to a direction perpendicular to the solar cells.

In some embodiments, the solar cells may be subcells of multi junction photovoltaic cells.

In some embodiments, the spectrometer input device may be fitted with an arrangement of optical elements. The arrangement of optical elements may be configured to selectively transmit the luminescent radiation emitted by said solar cells and selectively reject incident solar radiation.

In some embodiments, the optical elements may include a mirror positioned at about a 45 degree angle relative to a receiving plane of the module.

In some embodiments, the optical elements may include a narrow field-of-view optical coupler designed and positioned to selectively capture the luminescent radiation of the solar cells as reflected by the mirror.

According to further embodiments of the present invention, in a method of measuring a temperature of a semiconductor device or cell, bandgap characteristic shifts as a function of temperature are determined for the semiconductor cell. A luminescent emission of the semiconductor cell is captured, and one or more wavelength characteristic shifts indicated by the luminescent emission are correlated to the bandgap characteristic shifts as a function of temperature. A temperature of the semiconductor cell is determined responsive to the luminescent emission from the semiconductor cell and based on the correlating of the wavelength characteristic shifts to the bandgap characteristic shifts.

In some embodiments, the bandgap characteristic shifts for the semiconductor cell may be determined from quantum efficiency measurements and/or from a reference luminescence emission profile recorded for the semiconductor cell at a plurality of different temperatures.

In some embodiments, the luminescent emission may be a photo-luminescent emission having a first wavelength generated by the semiconductor cell responsive to electromagnetic radiation having a second wavelength. The first wavelength may be different from the second wavelength.

In some embodiments, the luminescent emission may be an electro-luminescent emission having a first wavelength generated by the semiconductor cell responsive to an electrical signal applied to the semiconductor cell.

In some embodiments, the semiconductor cell may be a semiconductor solar cell. For example, the semiconductor solar cell may be a multi-junction semiconductor solar cell.

In some embodiments, the semiconductor cell may be one of an array of semiconductor cells. The luminescent emission from the semiconductor cell may be captured by providing an optical coupler configured to selectively capture the luminescent emission from the semiconductor cell and to selectively exclude luminescent emissions from other semiconductor cells of the array.

In some embodiments, the array of semiconductor solar cells may be packaged in an enclosure, such as a concentrator-type photovoltaic module (CPV) enclosure. An optical coupler may be used to capture the luminescent emission from the semiconductor cell. The optical coupler may be outside the enclosure and/or otherwise remote from a surface of the semiconductor solar cell from which the luminescent emission is provided.

In some embodiments, an array of lenses may be provided adjacent the array of semiconductor cells, and each lens of the array of lenses may be provided for and adjacent to a respective one of the semiconductor cells of the array of semiconductor cells. The optical coupler may be oriented to capture the luminescent emission from the semiconductor cell through one of the lenses provided for another one of the semiconductor cells.

In some embodiments, an array of lenses may be provided adjacent the array of semiconductor cells, and each lens of the array of lenses may be provided for and adjacent to a respective one of the semiconductor cells of the array of semiconductor cells. Electromagnetic radiation may be provided through lenses of the array to other semiconductor cells of the array of semiconductor cells, and the electromagnetic radiation through one of the lenses of the array provided for the semiconductor cell may be blocked. The optical coupler may be oriented to capture the luminescent emission from the semiconductor cell through the one of the lenses of the array provided for the semiconductor cell.

In some embodiments, an array of lenses may be provided adjacent the array of semiconductor cells, and each lens of the array of lenses is provided for and adjacent to a respective one of the semiconductor cells of the array of semiconductor cells. Electromagnetic radiation may be provided through lenses of the array of lenses to the semiconductor cells of the array of semiconductor cells. The luminescent emission from the semiconductor cell may be captured by orienting a mirror to reflect the luminescent emission from the semiconductor cell to the optical coupler. The mirror may be configured to permit the electromagnetic radiation through the array of lenses to the semiconductor cell.

In some embodiments, the determined temperature may be a temperature rise value of the semiconductor cell.

According to yet further embodiments of the present invention, an apparatus includes a detector configured to capture luminescent emission from a semiconductor device or cell, and a processor coupled to the detector. The processor is configured to correlate one or more wavelength characteristic shifts indicated by the luminescent emission to bandgap characteristic shifts for the semiconductor cell as a function of temperature, and to determine a temperature of the semiconductor cell based on the correlation.

In some embodiments, the apparatus may further include a memory having the bandgap characteristic shifts for the semiconductor cell stored therein. The bandgap characteristic shifts for the semiconductor cell may be determined from quantum efficiency measurements and/or from a reference luminescence emission profile recorded for the semiconductor cell at a plurality of different temperatures.

In some embodiments, the semiconductor cell may be one of an array of semiconductor cells. The detector may include an optical coupler configured to selectively capture the luminescent emission from the semiconductor cell and to selectively exclude luminescent emissions from other semiconductor cells of the array.

In some embodiments, the detector may be configured to orient the optical coupler to capture the luminescent emission from the semiconductor cell through one of the lenses provided for another one of the semiconductor cells.

In some embodiments, the detector may be configured to block the electromagnetic radiation through one of the lenses of the array provided for the semiconductor cell and to orient the optical coupler to capture the luminescent emission from the semiconductor cell through the one of the lenses of the array provided for the semiconductor cell.

In some embodiments, the detector may be configured to orient a mirror to reflect the luminescent emission from the semiconductor cell to the optical coupler. The mirror may be configured to permit or allow electromagnetic radiation through the array of lenses to the semiconductor cell.

Other methods, systems, and/or devices according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

The above and other features and/or advantages of embodiments of the present invention will become evident upon review of the following summarized and detailed descriptions in conjunction with the accompanying drawings:

FIG. 1 is a block diagram illustrating operations for determining a temperature of a solar cell according to some embodiments of the present invention.

FIG. 2 is a schematic illustration of a method of measuring photo-luminescent light emitted by a solar cell located inside a CPV module exposed to a light source according to some embodiments of the present invention.

FIG. 3 is a schematic illustration of a method of shadowing and measuring electro-luminescent light emitted by a solar cell located inside a CPV module according to some embodiments of the present invention.

FIG. 4A is a graph illustrating multiple electro-luminescence emission spectrums of an InGaP solar sub-cell at different operating temperatures according to some embodiments of the present invention.

FIG. 4B is a graph illustrating the extracted electro-luminescence emission peak wavelength positions as a function of temperature for an InGaP sub-cells from an InGaP/GaAs/GaInNAs(Sb) solar cell according to some embodiments of the present invention.

FIG. 5A is a graph illustrating a computed temperature rise of a InGaP junction in a micro-transfer printed InGaP/GaAs/GaInNAs(Sb) solar cell as a function of a forward bias electrical heat load bias according to some embodiments of the present invention.

FIG. 5B is a graph illustrating a temperature rise measurement repeatability histogram distribution plot for a micro-solar cell forward biased under a constant 97 mA bias current according to some embodiments of the present invention.

FIG. 6 is a graph illustrating transient temperature measurements of a micro solar cell subjected to an electrical heat load according to some embodiments of the present invention.

FIG. 7 is a schematic illustration of an optical apparatus which can be used to record high resolution thermal maps of solar cells subjected to a heat load according to some embodiments of the present invention.

FIG. 8A illustrates a two-dimensional thermal map of a micro-solar cell subjected to an electrical heat load based on measurements generated using the optical apparatus presented on FIG. 7.

FIG. 8B illustrates a near-infrared image of a triple junction micro solar cell based on measurements collected using a shortwave infrared InGaAs camera according to some embodiments of the present invention.

FIG. 9 is a schematic illustration of an optical apparatus which can be used to perform non-contact temperature measurements of individual solar cells located inside a concentrator photovoltaic module according to some embodiments of the present invention.

FIG. 10 is a graph illustrating measurements of operating temperatures of a solar cell located inside a concentrator photovoltaic module collected using the optical apparatus presented on FIG. 9, as compared to temperature measurements of the exterior surface of a concentrator photovoltaic module enclosure collected using a standard thermocouple, and measurements of solar direct normal irradiance collected using a normal incidence Pyrheliometer.

### DETAILED DESCRIPTION OF EMBODIMENTS

Embodiments of the present invention may arise from realization that, in the field of characterization of photovoltaic solar cells or modules, non-contact methods for measuring operating temperatures of solar cells may be of benefit, for instance, in concentrator photovoltaic (CPV) modules.

Accordingly, some embodiments described herein provide methods and structures that can be used to perform accurate measurements of operating temperatures of isolated cells and/or fully interconnected cells inside a CPV module. These methods and structures may use relatively low cost CCD spectrometers to accurately measure the wavelength shifts of sub-cell electro-luminescence and/or photo-luminescence emission spectrum. The sub-cells' intrinsic bandgap temperature dependence relations can be used to indirectly compute each subcell operating temperature.

Methods and structures according to some embodiments of the present invention may provide several advantages. For example, in contrast with some conventional methods relying on measurement of the open circuit voltage of a single solar cell or an array of electrically interconnected solar cells, methods and structures according to some embodiments disclosed herein may be relatively insensitive to changes of incoming light spectrum, irradiance flux intensity, and/or electrical bias conditions which may be present across the terminals of a solar cell.

In addition, methods and structures according to some embodiments disclosed herein may be used to measure modules in the field in a non-disruptive manner. Methods and structures according to some embodiments disclosed herein may not require the module under test to be electrically disconnected from a string to perform some temperature measurements. Operating temperatures of each solar cell may be individually measured from outside of a module.

Also, methods and structures according to some embodiments disclosed herein may be relatively insensitive to current leakage (shunts), which may be present or which may develop over time as a solar cell degrades. Methods and structures according to some embodiments disclosed herein may also be used to record high resolution thermal maps of solar cells to detect bonding voids and/or hot-spots. Furthermore, methods and structures according to some embodiments disclosed herein may be used to perform fast transient thermal analysis of solar cells subjected to heat load stimulus.

When methods and structures according to some embodiments of the present invention are used to measure the temperature rise of solar cells embedded inside a CPV module, narrow field of view optics may be used to selectively collect the electro-luminescence and/or photo-luminescence emission spectrum of a selected solar cell. Methods and structures according to some embodiments of the present invention may be used to perform cell temperature measurements in a non-disruptive manner, using a CPV module which may be exposed to direct solar irradiance on a two-axis tracker.

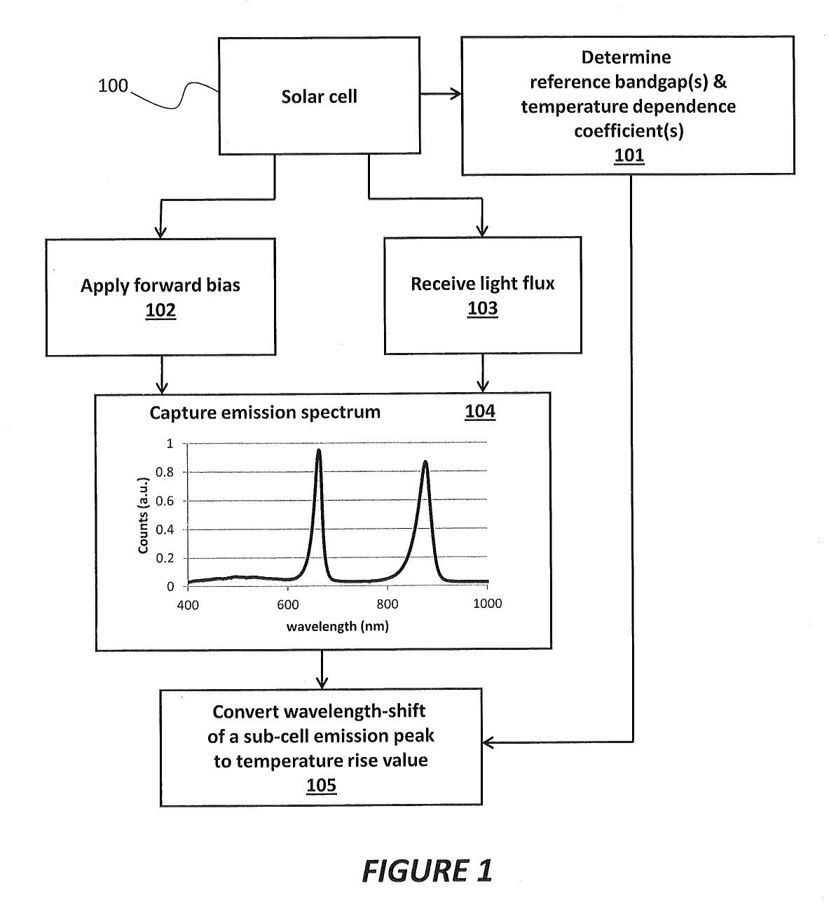

FIG. 1 is a block diagram illustrating operations for determining a temperature of a solar cell according to some embodiments of the present invention. Referring now to FIG. 1, for a solar cell 100, an emission spectrum is captured (at block 104) responsive to application of an forward electrical bias (at block 102) and/or receiving incident light flux (at block 103), and reference bandgap(s) and temperature-dependent coefficient(s) are determined (at block 101). The wavelength shift of a subcell emission peak is converted to a temperature rise value (at block 105), for example, based on correlating the wavelength shift to bandgap shift as a function of temperature determined from the reference bandgap(s), as described in greater detail below.

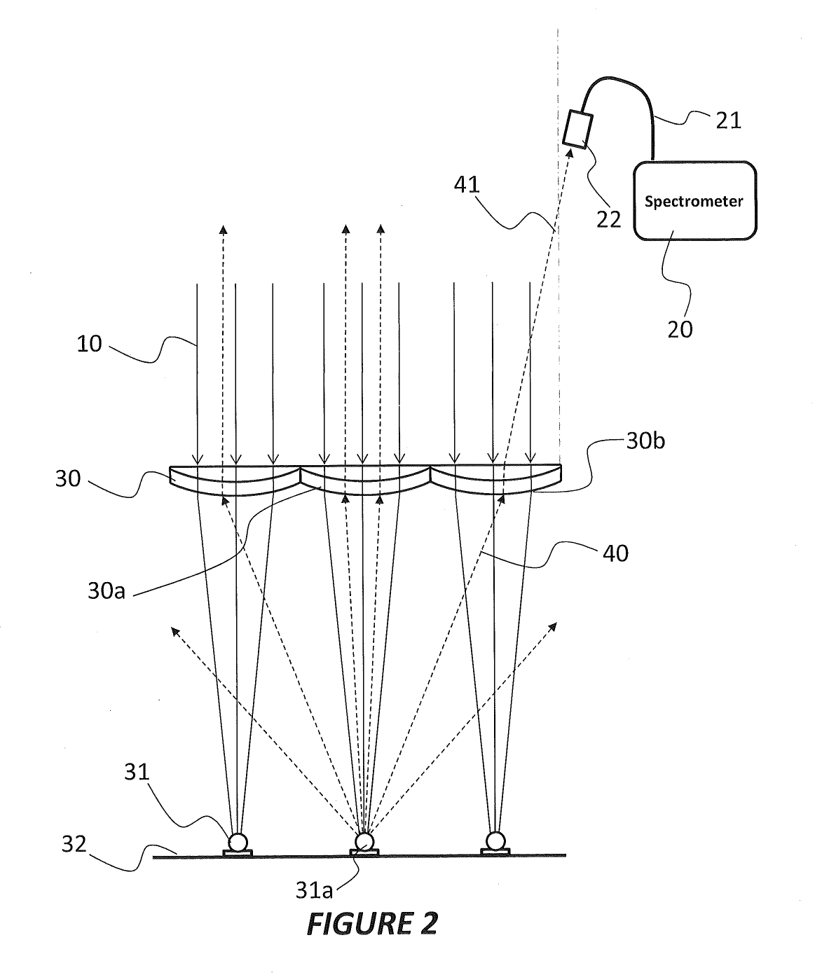

FIG. 2 is a schematic diagram illustrating some embodiments of the present invention for a CPV module having a primary lens array including multiple lenslets 30. Receivers 31, such as multi junction solar cells, are exposed to direct solar irradiance 10 concentrated by the primary optics 30. The multi-junction solar cells 31 may include one or multiple subcells, with each subcell including direct band semiconductors. When these subcells are left in open circuit bias condition and exposed to a broadband solar spectrum, a fraction of the incoming photons may be re-emitted by the solar cell through a process called photo-luminescence. Incident photons having higher energy (i.e., shorter wavelength) than the bandgap of a given subcell will be strongly absorbed in the subcell semiconductor layers. The photons that recombine in a radiative manner will re-emit new photons having an energy (i.e., wavelength) that is a function of and/or equal to the subcell semiconductor material bandgap value. The wavelength(s) of the newly-emitted photons may differ from that of the incident photons. Photons exiting the solar cell top surface in a non-collimated manner 40 may be collected by multiple lenslets 30 of the primary lens array, thus resulting in the generation of multiple partially collimated light beams 41 exiting the module at various angles. These photon beams may be collected and measured using a spectrometer 20, which may be equipped with an optical fiber 21 terminated by an optical coupler or detector 22. The optical coupler 22 and/or other measurement devices may be located outside of the CPV module. In some embodiments, the optical coupler 22 can be selected to have a narrow field-of-view to selectively receive photons radiatively emitted by a single or individual solar cell 31a, thus improving signal-to-noise ratio. In some embodiments, the optical coupler 22 may be aligned and pointed at an angle to more effectively collect photons 41 radiatively emitted from a receiver 31a through a lenslet 30b adjacent or located in direct proximity to the lenslet 30a that is aligned above the selected receiver 31a. In this configuration, the optical coupler 22 may be positioned at a sufficient distance from and/or at an angle with respect to a surface of the CPV module lens array 30 in order to reduce and/or avoid blocking of the incident direct normal solar irradiance 10.

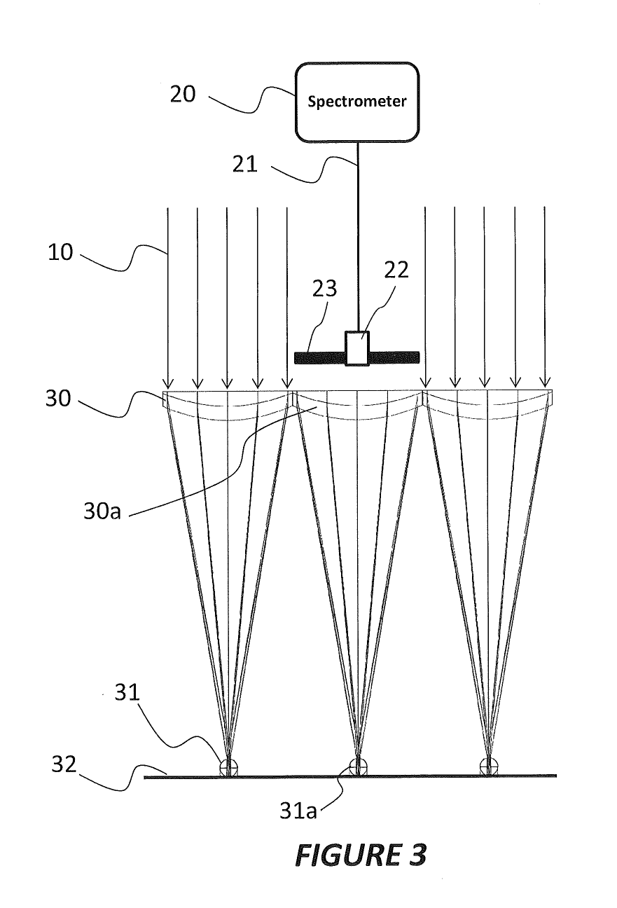

FIG. 3 illustrates further embodiments of the present invention, where an aperture plate 23 is attached to the optical coupler 22 to selectively block at least a portion or a fraction of the direct normal solar irradiance 10. In embodiments of FIG. 3, the optical coupler 22 may be oriented at a normal (e.g., perpendicular) angle immediately above a lenslet 30a that is positioned above a selected receiver 31a. In such case, the selected receiver 31a may receive little to none of the direct normal solar irradiance 10. In CPV modules having parallel-series interconnections, multiple receivers 31 may be interconnected in parallel blocks. The receivers 31 that are located in the same parallel block (as the selected shadowed receiver 31a) will continue to receive solar radiation 10 and thus produce an output voltage, which will be applied to the output terminal of the selected shadowed receiver 31a. This receiver 31a will thus be placed in a forward bias configuration, and can start to radiate or emit photons through a process called electro-luminescence. In the case of a multijunction solar cell composed of direct bandgap materials, each subcell will emit photons at wavelengths equal to each subcell semiconductor bandgap value. These photons may be collected through a primary lenslet 30a by the optical coupler 22 and transmitted to a spectrometer 20 through an optical fiber 21.

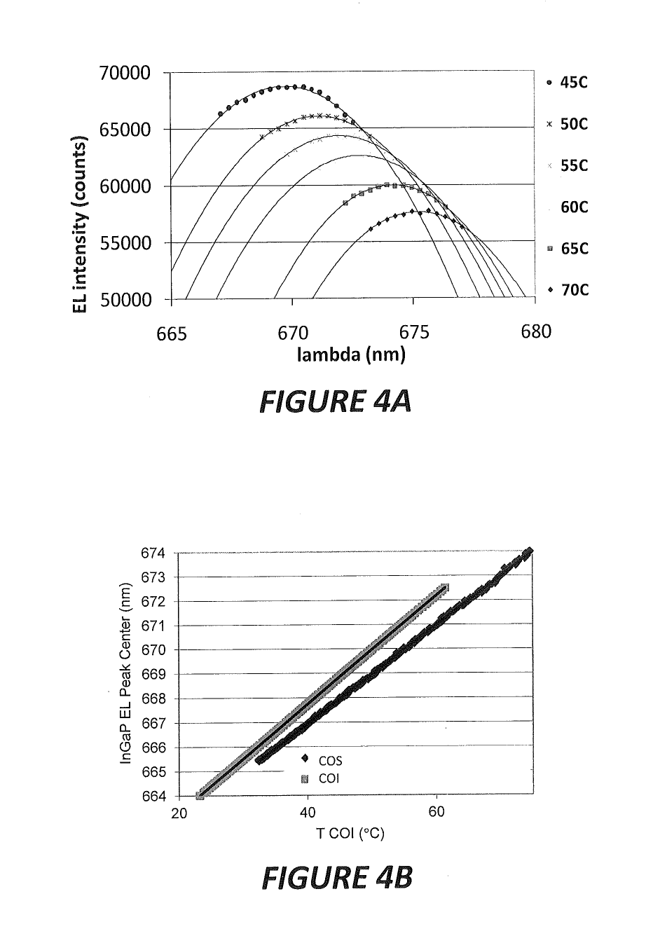

In some embodiments, methods and systems described herein may use the following operations. The sub-cells' intrinsic bandgap temperature dependence relations are used to indirectly compute each subcell operating temperature. The sub-cells' intrinsic bandgap temperature dependence coefficients can be measured by performing quantum efficiency measurements and/or by recording the electro-luminescence and/or photo-luminescence emission profile of a solar cell at multiple temperatures. FIG. 4A presents measurements of the electro-luminescence emission peak from an InGaP top cell of a lattice matched InGaP/GaAs/GaInNAs(Sb) triple-junction solar cell. The position of the sub-cell emission peak can be extracted with sub-nanometer accuracy using a second order polynomial curve fit. In the specific case of ultra-thin micro-transfer printed solar cells, mechanical properties of the interposer substrate may need to be taken into account, as this substrate may have a coefficient of thermal expansion that is different (often significantly) than the solar cell epi stack. As shown in FIG. 4B, due to the lower CTE (coefficient of thermal expansion) value of silicon substrates, a reduced bandgap temperature coefficient can be observed in the case of micro-solar cells transfer printed onto silicon interposer substrates.

For a given batch of epi-material, the variation of the epi material bandgap across a source wafer is typically very narrow (σ<0.1%). So, the material bandgap value measured under a reference temperature (25° C.) can be assumed to be substantially constant for multiple cells originating from a single source wafer. If the material bandgap value is not known, it can be extracted from the temperature calibration curve shown in FIG. 4B. Once a reference bandgap value and the sub-cell temperature dependence coefficient are known, absolute measurements of a sub-cell operating temperature can be performed for any irradiance flux level or bias current value.

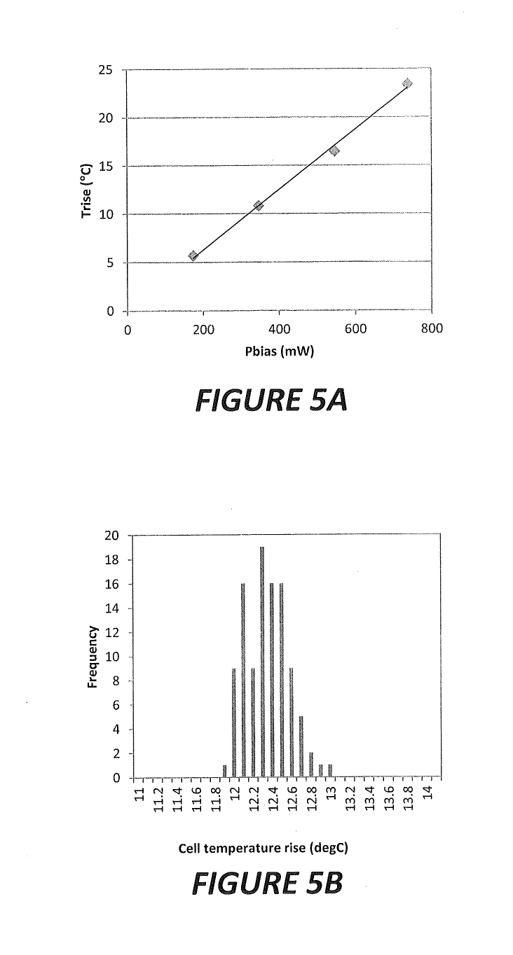

For example, FIG. 5A illustrates the extracted temperature rise of an InGaP/GaAs/GaInNAs(Sb) solar cell micro-transfer printed onto a ceramic interposer substrate as function of the forward electrical bias (Pbias=Ibias*Vbias4w) heat load applied to the cell. To reduce and/or avoid measurement errors, a 4-point probe measurement technique can be used to accurately compute the effective power of the electrical load applied to the cell. Using this technique, the operating temperature of each sub-cell can be accurately computed. Limitations of accuracy of measurements may be related to resolution and/or sensitivity of the selected spectrometer instrument. In the case of a relatively low cost JAZ® spectrometer, a measurement error of less than about 0.7° C. @±3σ can be achieved, as shown in FIG. 5B.

As explained above, measurement techniques according to embodiments of the present invention can be used to measure or estimate the temperature of a solar cell under a forward bias electrical heat load and/or a light flux. Such measurements may be performed on individual solar cells using, for example, a standard probe station test station equipped with a spectrometer.

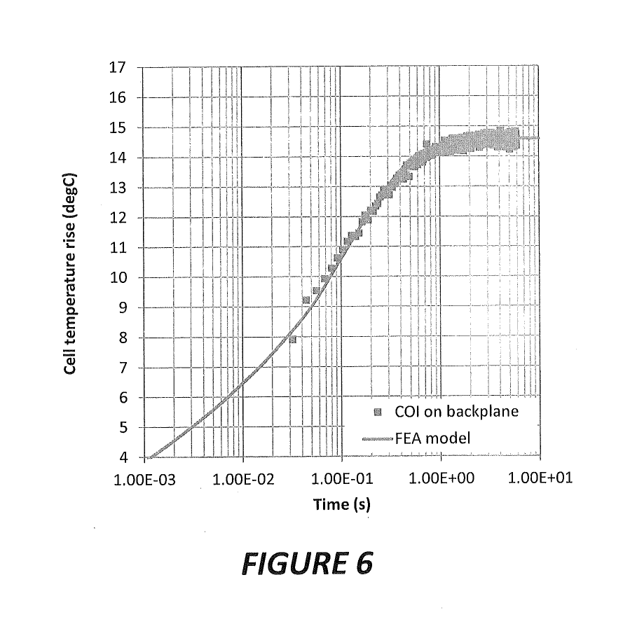

Measurement techniques according to embodiments of the present invention can be used to perform temperature measurements at high sampling rates, and may thus be appropriate to perform transient thermal analysis of solar cells subjected to a head load stimulus. FIG. 6 illustrates transient temperature measurements of a micro solar cell which was subjected to an electrical heat load. In FIG. 6, the micro-solar cell was forward biased and subjected to a constant forward current of 97 mA. Application of this electrical load induced a total heat load of 340 mW into the solar cell under test. The results of transient finite element analysis (FEA) thermal simulation runs presented in FIG. 6 (shown by the solid line) are in substantial agreement with these experimental measurements (shown by the dotted line). The micro-solar cell transient temperature rise was extracted using herein disclosed methods by performing an analysis of the wavelength shift of the InGaP sub-cell. Spectrums of solar cell electroluminescence were acquired using a standard fiber coupled CCD spectrometer (JAZ® instrument manufactured by Ocean Optics).

In contrast to standard temperature measurement techniques relying on use of IR detectors and/or thermocouples, measurement techniques according to embodiments of the present invention can be used to perform measurements of operating temperatures of a concentrator solar cell which may be fitted with secondary optical elements, such as a cell mounted in a CPV module. The visible and/or near-infrared light emitted by the concentrator sub-cells can be captured and analyzed in the same manner as the solar cell encapsulation layers, and secondary optical elements may be transparent to these wavelengths.

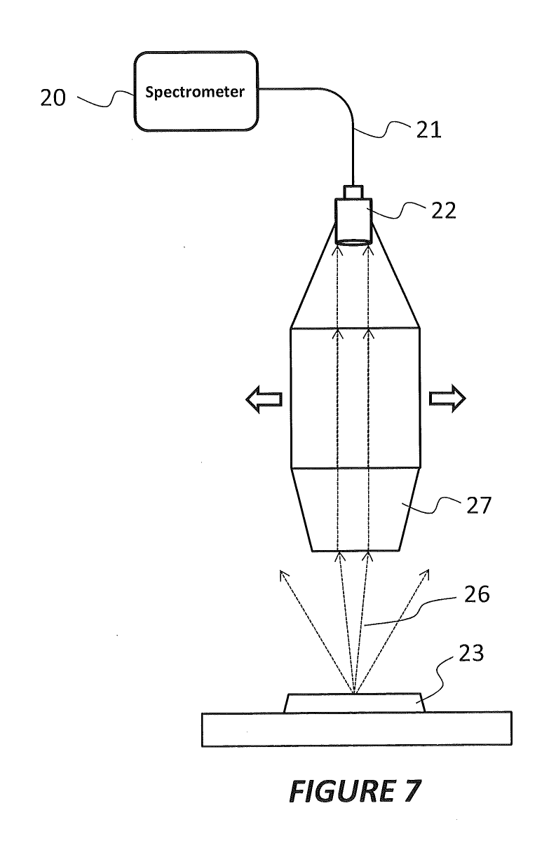

In addition, an optical apparatus including optical lenses can be used to record bi-dimensional thermal maps of solar cells subjected to a heat load. The heat load can be applied using an electrical bias and/or using focused electromagnetic radiation such as LASER light. FIG. 7 illustrates an optical apparatus which can be used to collect such thermal maps using methods and structures according to embodiments of the present invention. This apparatus may restrict the angular field of view of the spectrometer to selectively collect electro-luminescence and/or photo-luminescence from a small area of the solar cell 23 under test. Such an optical apparatus may include a set of lenses 27 such as a standard microscope objective. The electro-luminescent and/or photo-luminescent light 26 emitted by a concentrator solar cell 23 may be placed at a distance equal to the focal length of the optical apparatus lenses 27. In such configuration, a standard microscope objective projects an image to infinity of a restricted area of the solar cell. The light projected by the microscope objective may be captured by a fiber-coupled spectrometer 20 which may be fitted with an optical coupler 22 to increase light collection throughput. The size of area under examination may be a function of the objective magnification and/or the capture area of the optical coupler or fiber diameter (if no coupler is used). The microscope objective may be moved relative to the solar cell 23 under test to collect multiple measurements which may be arranged to form a high resolution bi-dimensional map.

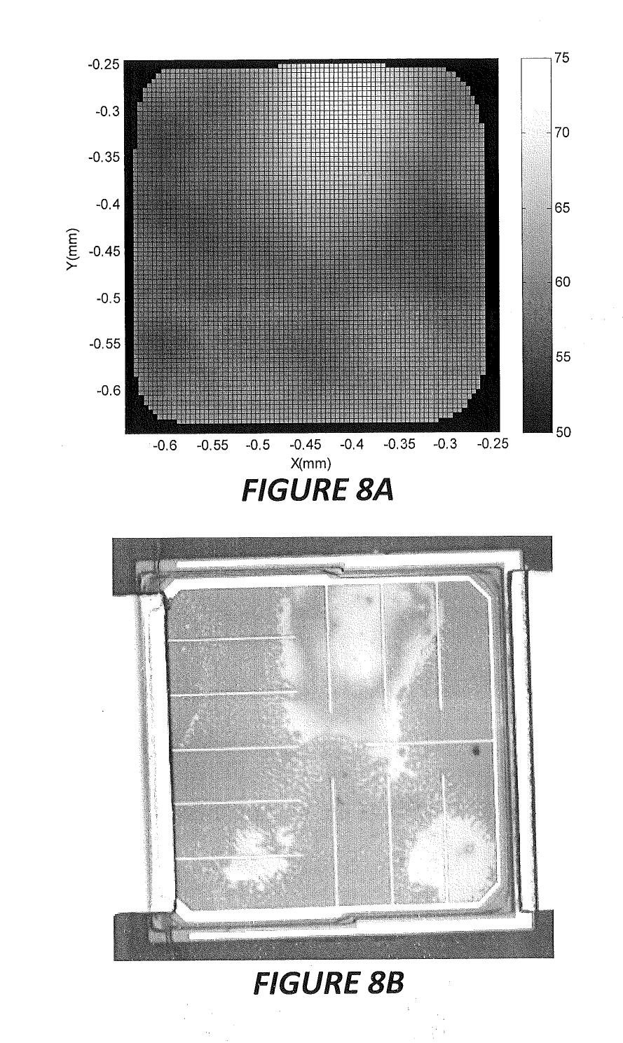

FIG. 8A illustrates an example of a bi-dimensional thermal map which was acquired using the optical apparatus of FIG. 7. The micro-solar cell was subjected to a heat load resulting from the application of a forward electrical bias. The map of FIG. 8A depicts an area of the micro-solar cell which is operating at a higher temperature. These results illustrate capabilities of techniques disclosed herein to spatially resolve operating temperatures of concentrator solar cells. Analysis of the bonded interface under the solar cell using a near infrared InGaAs camera revealed the presence of a large void in this area, as shown in FIG. 8B.

In a similar manner, these techniques can be used to measure operating temperatures of an array of solar cells located within a concentrator photovoltaic module. In such a configuration, the existing optics of the concentrator photovoltaic module itself may be used to collect the electro-luminescent and/or photo-luminescent light emitted by each solar cell. The concentrator photovoltaic module may be forward biased to perform indoor measurements, or a specific optical apparatus may be used to perform measurements in the field when the solar cells are exposed to concentrated sunlight.

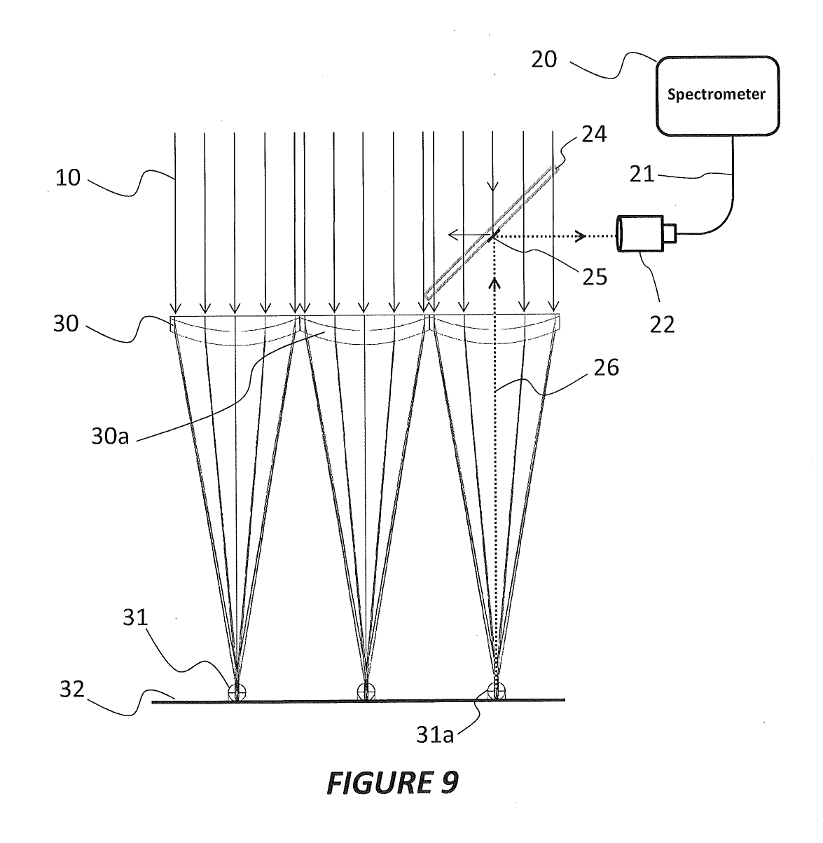

FIG. 9 illustrates an optical apparatus which may be used to measure or estimate operating temperatures of individual solar cells located inside a concentrator photovoltaic module from outside the module according to some embodiments of the present invention. The optical apparatus may include a mirror 25 oriented at about a 45 degree angle relative to a plane defined by the concentrator photovoltaic module primary optics array 30. In particular embodiments, the mirror 25 may be fabricated by patterning a thin metal layer deposited onto the surface of a transparent glass plate 24. In particular embodiments, the surface area of the mirror may be selected to be small relative to the glass plate 24 and/or the collection area of an individual lenslet of the concentrator photovoltaic module primary optics 30. In such a configuration, the mirror 25 may block a relatively small amount of the incident solar radiation 10, thus resulting in relatively little or negligible disruption to the operation of the concentrator photovoltaic module. When left in an open circuit condition, a fraction of the photons injected into the solar cell recombine in a radiative manner, leading to emission of photo-luminescent light 26. At least a portion or fraction of the photo-luminescent light 26 emitted by the solar cell is intercepted and reflected by the small mirror 25, and then collected by an optical coupler 22 coupled to spectrometer 20 by an optical fiber 21.

In particular embodiments, the optical coupler 22 is designed or otherwise configured to have a relatively small angular field of view, to selectively capture only the light that is reflected by the small mirror. In such a configuration, most of the incident and ambient solar radiation can be selectively rejected, thus resulting in improved and/or excellent signal-to-noise ratios. In some embodiments, the glass plate 24 supporting the small mirror 25 may be mechanically connected to the optical coupler 22 to form an optical apparatus, which may be positioned above any lenslet of the concentrator photovoltaic module primary optics 30. Such an optical apparatus may be fitted with fixtures such as suction cups to secure its position onto the surface of the concentrator photovoltaic module primary lens plate 30. Depending on the concentrator photovoltaic module design, the primary optics 30 may include an arrangement having a single lens or multiple primary lenslets.

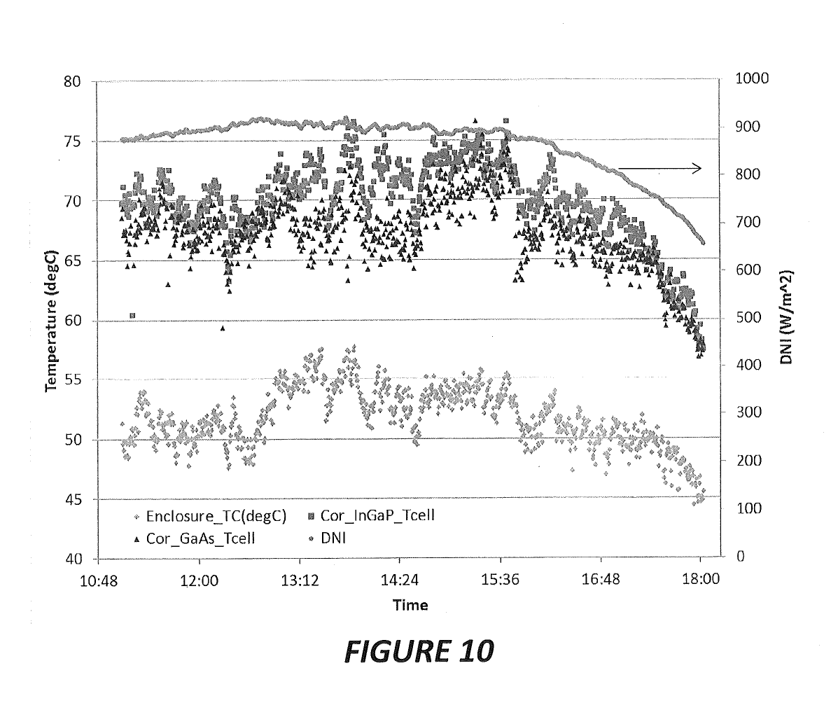

FIG. 10 illustrates measurements of operating temperatures of a solar cell located inside a concentrator photovoltaic module using an optical apparatus according to some embodiments of the present invention. FIG. 10 also illustrates temperature measurements of an exterior (bottom facing) surface of the concentrator photovoltaic module enclosure (which were collected using a standard thermocouple), as well as measurements of solar direct normal irradiance (which were collected using a normal incidence Pyrheliometer). Operating temperatures of the selected solar cell can be extracted using the peak emission of one or more of the sub-cells. In FIG. 10, the operating temperature of the solar cell under test was calculated using the peak position of the InGaP and GaAs sub-cells. Spectrums of the concentrator solar cell photo-luminescence were acquired using a standard fiber coupled CCD spectrometer during the course of a clear sky day. The temperature difference between the solar cell and the concentrator photovoltaic module enclosure increases proportionally as a function of the intensity of the focused light flux.

The present invention has been described above with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. In the drawings, the thicknesses of layers and regions and/or dimensions of elements may be exaggerated for clarity. Like numbers refer to like elements throughout.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the specification, there have been disclosed embodiments of the invention and, although specific terms are employed, they are used in a generic and descriptive sense only and not for purposes of limitation.

That which is claimed:

1. A method of determining a temperature and/or temperature changes of a solar cell in an array of solar cells emitting luminescent radiation, said method comprising:
establishing bandgap characteristic shifts corresponding to temperature shifts of said solar cells emitting luminescent radiation;
positioning a spectrometer input device to measure wavelength characteristic shifts of said luminescent radiation from said solar cells emitting luminescent radiation;
measuring said wavelength characteristic shifts of said luminescent radiation from said solar cells emitting luminescent radiation; and
correlating said wavelength characteristic shifts of said luminescent radiation from said solar cells emitting luminescent radiation to the bandgap characteristic shifts corresponding to temperature shifts of said solar cells to determine said temperature and/or temperature changes of said solar cells emitting luminescent radiation.

2. The method of claim 1, wherein said luminescent radiation is emitted responsive to incident solar radiation on said solar cells.

3. The method of claim 1, wherein said luminescent radiation is emitted responsive to application of a forward electrical bias to said solar cells.

4. The method of claim 1, wherein said positioning of said spectrometer input device is at an angle with respect to a direction perpendicular to said solar cells.

5. The method of claim 1, wherein said solar cells are subcells of multi junction photovoltaic cells.

6. The method of claim 1, wherein said spectrometer input device is fitted with an arrangement of optical elements that is configured to selectively transmit the luminescent radiation emitted by said solar cells and selectively reject an incident solar radiation.

7. The method of claim 6, wherein said optical elements comprise a mirror positioned at about a 45 degree angle relative to a receiving plane of said module.

8. The method of claim 7, wherein said optical elements comprise a narrow field of view optical coupler designed and positioned to selectively capture the luminescent radiation of said solar cells as reflected by said mirror.

9. A method of measuring a temperature of a semiconductor device, the method comprising:
determining bandgap characteristic shifts as a function of temperature for the semiconductor device;
capturing luminescent emission of the semiconductor device;
correlating one or more wavelength characteristic shifts indicated by the luminescent emission to the bandgap characteristic shifts as a function of temperature; and
determining a temperature of the semiconductor device responsive to the luminescent emission from the semiconductor device and based on the correlating of the wavelength characteristic shifts to the bandgap characteristic shifts.

10. The method of claim 9, wherein the bandgap characteristic shifts for the semiconductor device are determined from quantum efficiency measurements or from a reference luminescence emission profile recorded for the semiconductor device at a plurality of different temperatures.

11. The method of claim 9, wherein the luminescent emission comprises a photo-luminescent emission having a first wavelength generated by the semiconductor device responsive to electromagnetic radiation having a second wavelength.

12. The method of claim 9 wherein the luminescent emission comprises an electro-luminescent emission having a first wavelength generated by the semiconductor device responsive to an electrical signal applied to the semiconductor device.

13. The method of claim 9, wherein the semiconductor device comprises a semiconductor solar cell.

14. The method of claim 13, wherein the semiconductor solar cell comprises a multi-junction semiconductor solar cell.

15. The method of claim 13, wherein the semiconductor solar cell comprises one of an array of semiconductor solar cells packaged in an enclosure, and wherein capturing the luminescent emission from the semiconductor solar cell comprises:
providing an optical coupler configured to capture the luminescent emission from the semiconductor solar cell, wherein the optical coupler is remote from a surface of the semiconductor solar cell from which the luminescent emission is provided.

16. The method of claim 15, wherein the optical coupler is configured to selectively capture the luminescent emission from the semiconductor solar cell and to selectively exclude luminescent emissions from other semiconductor solar cells of the array.

17. The method of claim 16, wherein an array of lenses is provided adjacent the array of semiconductor solar cells, wherein each lens of the array of lenses is provided adjacent to a respective one of the semiconductor solar cells of the array of semiconductor cells, and wherein capturing the luminescent emission from the semiconductor solar cell comprises:
orienting the optical coupler to capture the luminescent emission from the semiconductor solar cell through one of the lenses provided adjacent another one of the semiconductor solar cells.

18. The method of claim 16, wherein an array of lenses is provided adjacent the array of semiconductor solar cells, wherein each lens of the array of lenses is provided adjacent to a respective one of the semiconductor solar cells of the array of semiconductor solar cells, the method further comprising:
providing electromagnetic radiation through lenses of the array to other semiconductor solar cells of the array of semiconductor solar cells; and
blocking the electromagnetic radiation through one of the lenses of the array provided adjacent to the semiconductor solar cell;
wherein capturing the luminescent emission from the semiconductor solar cell comprises orienting the optical coupler to capture the luminescent emission from the semiconductor solar cell through the one of the lenses of the array provided adjacent to the semiconductor solar cell.

19. The method of claim 16, wherein an array of lenses is provided adjacent the array of semiconductor solar cells, wherein each lens of the array of lenses is provided adjacent to a respective one of the semiconductor solar cells of the array of semiconductor solar cells, the method further comprising:
providing electromagnetic radiation through lenses of the array of lenses to the semiconductor solar cells of the array of semiconductor solar cells;
wherein capturing the luminescent emission from the semiconductor solar cell comprises orienting a mirror to reflect the luminescent emission from the semiconductor solar cell to the optical coupler, wherein the mirror is configured to allow the electromagnetic radiation through the array of lenses to the semiconductor solar cell.

20. The method of claim 9, wherein the temperature comprises a temperature rise value of the semiconductor cell.

21. An apparatus, comprising:
a detector configured to capture luminescent emission from a semiconductor device; and
a processor configured to correlate one or more wavelength characteristic shifts indicated by the luminescent emission to bandgap characteristic shifts for the semiconductor device as a function of temperature, and to determine a temperature of the semiconductor device based on the correlation.

22. The apparatus of claim 21, further comprising:
a memory including the bandgap characteristic shifts for the semiconductor device stored therein,
wherein the bandgap characteristic shifts for the semiconductor device are determined from quantum efficiency measurements or from a reference luminescence emission profile recorded for the semiconductor device at a plurality of different temperatures.

23. The apparatus of claim 21, wherein the luminescent emission comprises a photo-luminescent emission having a first wavelength generated by the semiconductor device responsive to electromagnetic radiation having a second wavelength.

24. The apparatus of claim 21, wherein the luminescent emission comprises an electro-luminescent emission having a first wavelength generated by the semiconductor device responsive to an electrical signal applied to the semiconductor device.

25. The apparatus of claim 21, wherein the semiconductor device comprises a semiconductor solar cell.

26. The apparatus of claim 25, wherein the semiconductor solar cell comprises a multi-junction semiconductor solar cell.

27. The apparatus of claim 25, wherein the semiconductor solar cell comprises one of an array of semiconductor solar cells packaged in an enclosure, and wherein the detector comprises:
an optical coupler configured to capture the luminescent emission from the semiconductor solar cell, wherein the optical coupler is remote from a surface of the semiconductor solar cell from which the luminescent emission is provided.

28. The apparatus of claim 27, wherein the optical coupler is configured to selectively capture the luminescent emission from the semiconductor solar cell and to selectively exclude luminescent emissions from other semiconductor solar cells of the array.

29. The apparatus of claim 28, wherein an array of lenses is provided adjacent the array of semiconductor solar cells, wherein each lens of the array of lenses is provided adjacent to a respective one of the semiconductor solar cells of the array of semiconductor solar cells, and wherein the detector is configured to orient the optical coupler to capture the luminescent emission from the semiconductor solar cells through one of the lenses provided adjacent another one of the semiconductor solar cells.

30. The apparatus of claim 28, wherein an array of lenses is provided adjacent the array of semiconductor solar cells, wherein each lens of the array of lenses is provided adjacent to a respective one of the semiconductor solar cells of the array of semiconductor solar cells, wherein the detector is configured to block the electromagnetic radiation through one of the lenses of the array provided adjacent the semiconductor solar cell and to orient the optical coupler to capture the luminescent emission from the semiconductor solar cell through the one of the lenses of the array provided adjacent the semiconductor solar cell.

31. The apparatus of claim 28, wherein an array of lenses is provided adjacent the array of semiconductor solar cells, wherein each lens of the array of lenses is provided adjacent to a respective one of the semiconductor solar cells of the array of semiconductor solar cells, wherein the detector is configured to orient a mirror to reflect the luminescent emission from the semiconductor solar cell to the optical coupler, wherein the mirror is configured to allow electromagnetic radiation through the array of lenses to the semiconductor solar cell.

32. The apparatus of claim 21, wherein the temperature comprises a temperature rise value of the of the semiconductor cell.
